(19) United States
(12) Patent Application Publication
(10) Pub. No.: US 2026/0211853 A1
(43) Pub. Date: Jul. 23, 2026

(54) Systems, Methods and Computer-Readable Media for Migrating Data

(71) Applicant: Xero Limited, Te Aro, Wellington (NZ)

(72) Inventor: Geoff Thornburrow, Te Aro, Wellington (NZ)

(21) Appl. No.: 19/119,315

(22) PCT Filed: Oct. 12, 2023
(86) PCT No.: PCT/NZ2023/050106

§ 371 Date: Apr. 8, 2025

(30) Foreign Application Priority Data
Oct. 14, 2022 (AU) 2022903012

(51) Int. Cl. G06F 16/21; G06F 16/22

(52) U.S. Cl. CPC G06F 16/214; G06F 16/2255

(57) ABSTRACT

A method includes: copying rows from an origin database to a target database; iteratively performing: calculating for a row in the target database a first hash value; mapping the first hash value to a position in the target hash array, the target hash array being longer than the first hash value; incorporating the first hash value into the target hash array at the position; iteratively performing: calculating for a row in the origin database a second hash value; mapping the second hash value to a position in the origin hash array, the origin hash array being longer than the second hash value; incorporating the second hash value into the origin hash array at the position; and comparing the origin hash array to the target hash array to verify the multiple rows in the target database against the multiple rows in the origin database.

### TECHNICAL FIELD

Embodiments generally relate to systems, methods and computer-readable media for migrating data from an origin database to a target database. Some embodiments relate to and in particular, systems, methods and computer-readable media that migrate data while preserving cross-references between different tables from the origin database.

### BACKGROUND

Relational databases store large amounts of data in logical tables with rows and columns. A database management system (DBMS) creates new rows and writes data into the columns of the rows. Most DBMSs are designed to store a large number of rows in a large number of tables. In some cases, however, there is a need to migrate a database from one DBMS to another. However, this poses difficulties both in data integrity as well as performance.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

### SUMMARY

Some embodiments relate to a method comprising: copying multiple rows from an origin database to a target database; iteratively performing the following steps for each of the multiple rows in the target database that were copied from the origin database to calculate a target hash array: calculating for that row in the target database a first hash value; mapping the first hash value to a position in the target hash array, the target hash array being longer than the first hash value; incorporating the first hash value into the target hash array at the position; iteratively performing the following steps for each of the multiple rows in the origin database that were copied to the target database to calculate an origin hash array: calculating for that row in the origin database a second hash value; mapping the second hash value to a position in the origin hash array, the origin hash array being longer than the second hash value; incorporating the second hash value into the origin hash array at the position; and comparing the origin hash array to the target hash array to verify the multiple rows in the target database against the multiple rows in the origin database.

In some embodiments, mapping the first second hash value to the position in the target hash array is based on the first hash value.

In some embodiments, mapping the first hash value to the position in the target hash array is based on one or more bytes of the first hash value.

In some embodiments, the one or more bytes are leading bytes.

In some embodiments, mapping the first hash value to the position in the target hash array comprises multiplying the one or more bytes of the first hash value by a mapping factor and using the result of the multiplying as an index in the target hash array.

In some embodiments, multiplying the mapping factor with a maximum value of the one or more bytes results in the length of the target hash array.

In some embodiments, the target hash array wraps around in case the first hash value overflows the target hash array.

In some embodiments, incorporating the first hash value into the target hash array comprises adding the first hash value to values in the target hash array at the position.

In some embodiments, the first hash value has 32 bytes and the target hash array has 256 bytes.

In some embodiments, the steps of calculating, mapping and incorporating are identical for creating the target hash array and for creating the origin hash array.

Some embodiments relate to a method comprising: creating an origin database by repeatedly adding rows to the origin database, each row comprising an attribute indicative of a physical location at which that row is stored on a non-volatile storage medium; reading the rows from the origin database in the order of the attribute indicative of the physical location; and writing the rows from the origin database to a target database to migrate the origin database to the target database.

In some embodiments, the attribute is a number that is incremented each time a row is added to the origin database.

In some embodiments, each row added to the origin database comprises a primary key, different from the attribute indicative of the physical location, the primary key being unique to the origin database and the target database.

Some embodiments relate to a method comprising: analysing a schema of an origin database to determine, for multiple tables in the origin database, an order of dependency in which to migrate the multiple tables to a target database; generating references in the origin database to cross-reference rows in different tables independent from a primary key of the different tables; copying the multiple tables in the order of dependency and including the references in the target database; and using the references in the target database to replace primary key values in the target database and assigned by the origin database with primary key values assigned by the target database.

In some embodiments, copying the multiple tables comprises copying rows of each of the tables according to an order as the rows are stored on a non-volatile storage medium.

In some embodiments, analysing the schema comprises identifying dependencies and wherein the order comprises positioning a first table of the multiple tables before a second table of the multiple tables if the second table depends on the first table.

In some embodiments, a dependency of a first table of the multiple tables on a second table of the multiple tables comprises a use of a foreign key in the first table, the foreign key reflecting a primary key in the second table.

In some embodiments, a first table of the multiple tables depends on a second table of the multiple tables and the method comprises copying the second table before the first table.

In some embodiments, the step of replacing the primary key values in the target database is performed for a table of the multiple tables copied from the origin database and before copying a further table of the multiple tables from the origin database.

In some embodiments, generating references comprises adding a reference column to each of the multiple tables and storing the references in the reference column.

In some embodiments, each of the multiple tables in the origin database has a corresponding table in the target database and the reference is unique across one of the multiple tables in the origin database and the corresponding table in the target database.

In some embodiments, generating the references comprises generating one reference for each primary key value in the origin database.

In some embodiments, a first table of the multiple tables depends on a second table of the multiple tables and generating the references comprises generating the reference for each row in the second table and using that reference for each corresponding foreign key in the first table.

Some embodiments relate to a method comprising: monitoring access to the origin database over a period of time to capture usage data; determining, based on the usage data, one or more time slots where usage of the database is at a minimum; determining a data migration period based on the one or more time slots; inhibiting updates to the origin database during the data migration period to prevent changes to the origin database during migration; copying contents of the origin database to the target database; verifying contents on the target database copied from the origin database against the origin database; and upon successfully verifying the contents, permitting updates to the origin database.

In some embodiments, monitoring the access comprises capturing time stamps of operations performed on the origin database.

In some embodiments, the method further comprises aggregating the usage data for multiple pre-defined time slots.

Some embodiments relate to a system comprising: one or more processors; and memory comprising computer executable instructions, which when executed by the one or more processors, cause the system to perform the above method.

Some embodiments relate to a non-transitory machine-readable storage medium including instructions that, when executed by a machine, cause the machine to perform the above method.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### BRIEF DESCRIPTION OF DRAWINGS

Various ones of the appended drawings merely illustrate example embodiments of the present disclosure and cannot be considered as limiting its scope.

FIG. 1 is a schematic of an origin database and a target database, wherein data is copied from the origin database to the target database without preserving cross-references;

FIG. 2 is an improved schematic of an origin database and target database wherein data is copied from the origin database to the target database while preserving cross-references, according to some embodiments;

FIG. 3 illustrates a dependency graph of tables in the origin database used to determine an order of tables in which to copy the tables from the origin database to the target database, according to some embodiments;

FIG. 4 shows data objects involved in migrating data from an origin database to a target database, according to some embodiments;

FIG. 5 is a diagram illustrating a process for verifying data copied from an origin database to a target database, according to some embodiments;

FIG. 6 illustrates a process 600 for efficiently copying data from an origin database to a target database;

FIG. 7A is a diagram illustrating a process for migrating data from an origin database to a target database, according to some embodiments;

FIG. 7B is a diagram illustrating another process for migrating data from an origin database to a target database, according to some embodiments; and

FIG. 8 is a schematic of a communication system comprising an origin database and a target database, according to some embodiments.

### DESCRIPTION OF EMBODIMENTS

Embodiments generally relate to systems, methods and computer-readable media for migrating data from an origin database to a target database. Some embodiments relate to systems, methods and computer-readable media that migrate data while preserving cross-references between different tables from the origin database. Some examples disclosed herein may use nomenclature of specific database management systems (DBMS), such as Microsoft SQL Server or Oracle. It is noted, however, that this disclosure applies to all types of DBMSs. A DBMS may also be referred to as a database server.

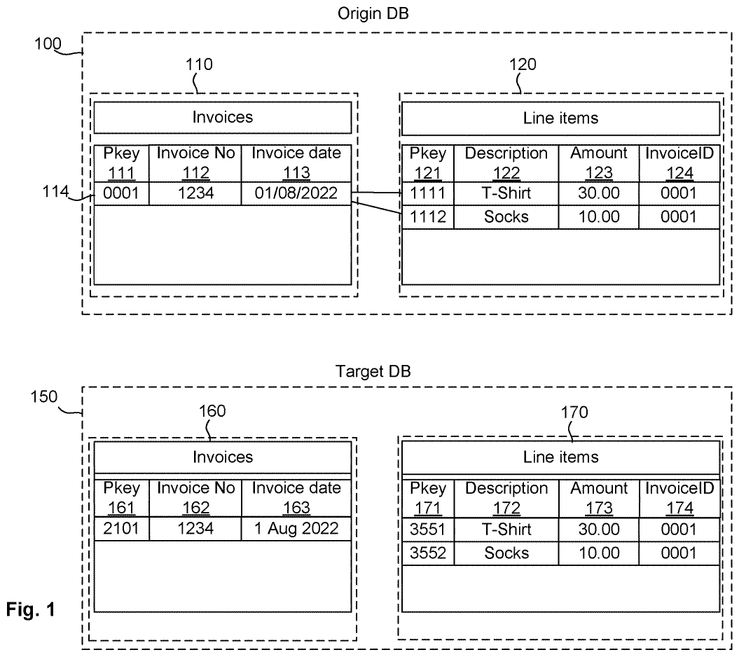

FIG. 1 is a schematic of an origin database 100 from which data is to be copied. FIG. 1 also shows a target database 150 into which the data is copied from the origin database. Origin database 100 comprises a first table, which is an invoices table 110 in this example, and a second table, which is a line items table 120 in this example. The following description uses the invoices table and line items table as examples noting that these may be replaced by other tables. The invoices table 110 has a primary key column 111, invoice number column 112 and invoice date column 113. It is noted that this example is simplified and typical tables tend to have more columns.

A first DBMS (not shown) hosts the invoices table 110 and the line items table 120, which means the first DBMS generates the value for the primary key column 111 automatically each time a new row is added to the invoices table 101. In this example, only one row 114 is shown but typically, each table has a large number of rows.

Line items table 120 comprises a primary key column 121, a description column 122, an amount column 123 and an invoice identifier column 124. The invoice identifier column 124 holds a cross-reference to the invoice table 110. This means the invoice identifier column 124 of line items that relate to a particular invoice stores a value that is identical to one of the values in the primary key column 111 of the invoices table 110. In this example, the primary key of the invoice row 114 is “0001” and therefore, the value of the invoice identifier column 124 is also “0001”. When corresponding data is retrieved from the origin database 100, such as by querying for a particular invoice, the DBMS searches for all line items with the particular invoice primary key in the invoice identifier column 124. In one embodiment, the primary key column 111 of the invoices table has the same name as the invoice identifier column 124 and is specified as PRIMARY KEY. In that case, the query can be performed using the command of JOIN ON Invoice identifier. If the names are different, the JOIN operation specifies the column names such as SELECT*FROM Invoices INNER JOIN Line_items ON Invoices. Pkey=Line_items.InvoiceID.

The first DBMS also generates the value for the primary key column 121 automatically each time a new line item is added to the line items table 120. The automatic generation could be an increment function that adds ‘1’ to the previously generated primary key or another function that guarantees that the primary key value is unique within that table.

The line items table 120 has further columns for a description column 122, amount column 123 and invoice identifier column 124. When a new invoice is generated, the invoicing system creates one new record in invoices table 110 for that invoice and then for each line item of that invoice, the invoicing system creates a respective row in the line items table 120. In this simplified example, the line items table 120 stores the description column 122 and amount column 123 directly. In other examples, however, the description and amount are stored in a separate products table for each product and the line item only stores a product identifier. In general, it is desirable that the tables in the database 100 are stored in a standardised form, which is referred to as normalization. Normalization is the process of organizing data in a database. This includes creating tables and establishing relationships between those tables according to rules designed both to protect the data and to make the database more flexible by eliminating redundancy and inconsistent dependency.

The value in the invoice identifier column 124 is the value of the primary key of the row 114 in the invoices table 110 to which this line item belongs. So in this example, there is only one invoice item in invoices table 120 with primary key value ‘0001’. Both line items in line items table 120 relate to this invoice. Therefore, both line items have as the invoice identifier ‘0001’ which is the identifier of the invoice row 114 that they relate to.

It is noted that the invoice identifier column 124 creates a relationship (i.e. “cross-reference”) between the line items table 120 and the invoices table 110. This creates a dependency in the sense that the line items table 120 is said to depend on the invoices table 110. The invoice identifier in invoice identifier column 124 is also referred to as a “foreign key” because its values are the primary key of a different table. Defining them as foreign keys protects the database from accidentally deleting or otherwise unintentionally removing the relationship between the line items and the invoices.

Searching for entries in the origin database 100 typically works by creating an index that is faster to search than the actual rows of the tables. However, as the number of invoices grows, the size of the index also grows which slows down searches. One way to improve performance in that case is by a process referred to as “sharding”, which means the horizontal division of the database. This means that sets or rows of a table are stored on different servers, such as in the target database 150. While this improves performance significantly, there is an overhead in complexity. In particular, it is difficult to migrate rows between servers if it turns out that a particular shard is too large or too small.

In particular, when rows are copied from origin database 100 to target database 150, new rows are created in target database 150. However, when new rows are created, the primary keys of those new rows are generated automatically and in most cases are different from the primary key in the origin database 100. As a result, the relationship between the line items and the invoices is broken. This is shown in FIG. 1 where target database 150 also comprises an invoices table 160 and a line items table 170. Invoices table 160 comprises primary key column 161, invoice number column 162, invoice date column 163. Line items table comprises primary key column 171, description column 172, amount column 173 and invoice identifier column 174.

It can be seen in FIG. 1 that after the copying, the value in the invoice identifier column 174 in the line items table 170 is still the same as in the origin database 100 but there is no corresponding invoice row in the invoices table 160 because the primary key has been re-generated. In other cases, there is an entry in the invoices table but it is not the correct row for those line items. This shows that the cross-references in the origin database 100 are not preserved, which means it is difficult to copy rows from one database to another without breaking relationships between tables.

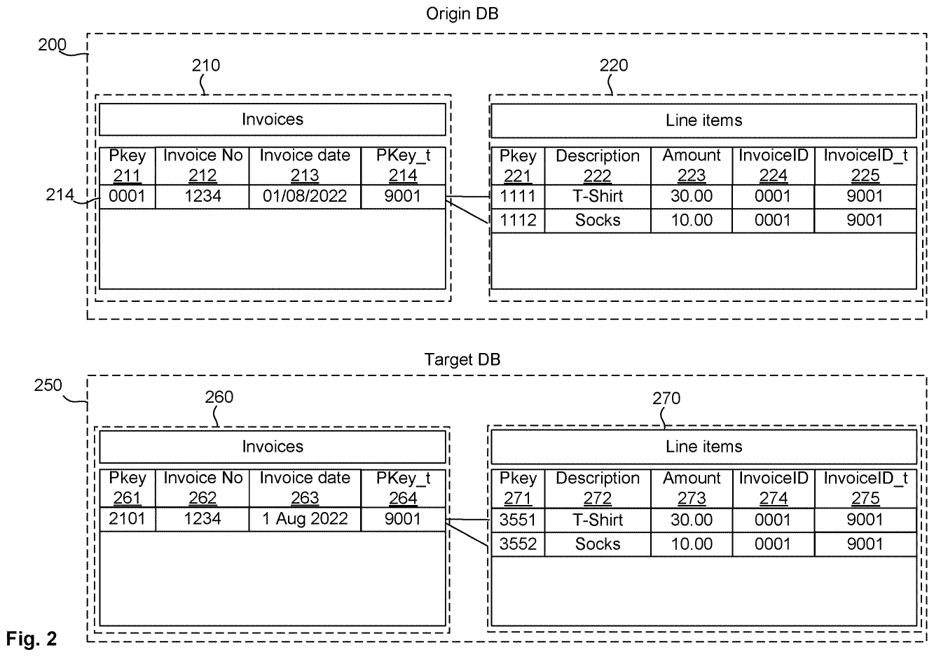

FIG. 2 illustrates an improvement again comprising origin database 200 and target database 250. As in FIG. 1, origin database 200 comprises a first table, which is an invoices table 210 in this example, with primary key column 211, invoice number column 212 and invoice date column 213. Origin database 200 further comprises a second table, which is a line items table 220 in this example, comprising a primary key column 221, description column 222, amount column 223 and invoice identifier column 224. Now, the DBMS generates an additional temporary primary key column 214 which holds, for each invoices row, a value that serves as a temporary primary key, therefore labelled as “PKey_t”. The temporary primary key may be generated when the copy process is initiated and may start from “1” and be incremented for each row to be copied. In other embodiments, the temporary primary key is generated while the database is in use at any time or period of time before the copy process. In that sense, the column referred to as “temporary” primary key is actually used as a permanent identifier of that column and can in fact be used as the primary key for that table instead of primary key column 221.

Once all temporary primary keys are generated for the invoices table 210, the DBMS searches for foreign keys in other tables, such as line items table 220. The DMBS then adds a temporary cross-reference, that is, a temporary invoice identifier column 225, such as “InvoiceID_t”, that is filled with the temporary primary key of the invoices table. This preserves the cross-references from the origin database 200 when the rows are copied into a different database. In this sense, the cross-references are now independent from the primary keys generated by the DBMS hosting the origin database 200.

In one embodiment, the temporary primary key is generated by a central computer that is central to the various different DBMSs. The central computer ensures that all temporary primary keys in different databases are unique, such as by maintaining a central counter that is incremented each time a new row is added to any database. In yet another embodiment, the central counter is maintained for each table name across the multiple databases. That is, there is an “Invoices” counter that provides a temporary primary key for any new row in any of the multiple invoices tables in origin database, target database and other involved databases. This may assume that the database structure, tables rows etc., which is also referred to as “schema” is the same across all involved databases.

Once the temporary primary key in temporary primary key column 214 is generated and added where a foreign key is used (i.e. in temporary invoice identifier column 225), the content of the origin database 200 can be copied to the target database 250. Now, the temporary primary key in columns 214 and 225 preserves the cross-references between the invoices and line items. As a final step, the process may include searching for the new primary key in column 261 in the target database 250 by searching for the temporary primary key in column 264 in the invoices table 260 and overwriting the invoice identifier in column 274 with the primary key from column 261 of the located invoice item. In the example, where the globally created value, referred to as “temporary primary key” is used as the actual primary key (instead of an auto-incremented counter), that search and overwrite may not be necessary.

In some embodiments, adding new rows to the origin database and modifying any values is halted during the copy progress. This means, the database is read-only or essentially taken offline, which may lead to user disruption. Therefore, the system may learn when a database is being used, such as by maintaining a counter for each of the 24 hours of each of the 7 days of the week and incrementing that counter every time the database is accessed. Those counters with a zero value indicate a time slot where copying can be performed with minimal disruption. In some embodiments, the queries for using the database, such as adding or modifying rows, are implemented such that they add a timestamp into a timestamp column every time a row is added or modified. The processor can then query for timestamps in particular time windows, such as each hour between 10 pm and 5 am to determine time windows with minimum activity. The processor then initiates the migration process in that time window with minimum activity. In yet another embodiment, the processor can query for all entries or for a fixed number of entries, construct a histogram of timestamps and identify the minimum in the histogram. The processor then initiates the migration process during the minimum in the histogram.

The tables of the database are copied in order of their dependencies from the schema and the rows of each table are copied in the order in which they are stored on the hard drive. The data is read out of the origin database, serialised (i.e. encoded), sent to the target database, de-serialised (i.e. decoded) and stored in the new rows.

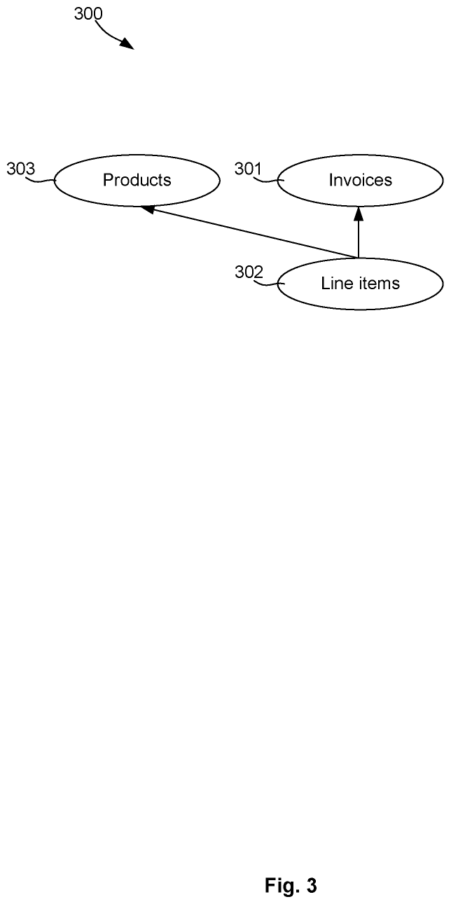

FIG. 3 illustrates a dependency graph 300 where nodes represent tables, such as invoices node 301, line items node 302 and products node 303 representing a table holding product information, such as description and price. Arrows indicate that a node at the base of the arrow depends on the node at the tip of the arrow. So for example, line items node 302 depends on invoices node 301 because the line items table contains a foreign key referencing the primary key of the invoices table as described above. Similarly, line items node 302 depends on products node 303 since the line items table also contains a foreign key referencing the primary key of the products table.

The copy process may now start at an arbitrary node and check whether all tables represented by nodes on which this node depends have been copied. So each node may have a “copied” flag indicating that the corresponding table has been copied. The process iterates over all outgoing edges of the current node and checks for each outgoing edge whether the connected node has the copied flag set. If a node is found that does not have the copied flag set, that node is set as the current node and the process repeated. If the current node has no outgoing edges, the table corresponding to that node is copied from the origin database 200 to the target database 250 and the flag set. Then, the process iterates over the incoming edges to find a node without the copied flag set. If such a node is found, the process checks whether all outgoing edges have the copied flag set and if so, copy the table corresponding to the current node and set the flag. This process is repeated until all tables are copied. In essence, this process performs a graph traversal to identify nodes representing tables that have not yet been copied and satisfy a copy criterion, which means they have no dependencies or only dependencies on tables that have already been copied.

So in the example of FIG. 3 all flags are unset. The process starts with the line items node 302, and checks the first outgoing edge and finds products node 303 that has an unset flag. Therefore, the process sets products node 303 as the current node. There are no outgoing edges so the process copies the products table and sets the flag of the products node. Then the process selects the first incoming edge (there is only one) and returns to line items node 302. Now the first outgoing edge has a flag set but the second outgoing edge to invoices node 301 does not have the flag set. So the process sets the current node as the invoices node 301, copies that table and sets the flag. Returning to line items node 302 the process now determines that all outgoing edges have flags set and can now copy the line items table.

Once the copy process is complete, the system may perform a validation process where a hash value of every new row in the target database is calculated and compared to the hash value of that row in the origin database. Since the primary keys and foreign keys have changed, and the order of columns may have changed, the hash function may be configured to be independent from the ordering and the primary and foreign keys. For example, there may be a centrally administered ordering of columns so that the hash value is computed from input values that are in the same order between the origin database 200 and the target database 250. Further, the foreign and primary keys may be excluded from the hash value calculation so as not to obtain different hash values because of different primary keys generated by the DBMS. In other examples, the schema of the origin database and the target database are identical, so the order of columns is also identical. This means ignoring the foreign and primary keys leads to identical hash values if the row contents are identical.

In another embodiment, the hash values of the multiple rows are combined so that it is not necessary to compare a large number of hash values, which would be difficult if the order of rows differs between the two databases. More particularly, if one hash is calculated for each row in the target database 250 and that hash is to be compared to all hashes calculated for all rows in the origin database, the computational complexity becomes quickly unacceptable for a large number of rows. One approach might be to calculate a hash value of the first row of the target database, concatenate that hash value with the second row and calculate a hash value of the concatenation, concatenate the result with the third row and so on. This operates like a blockchain that calculates a hash of hashes. However, this method is not commutative in the sense that the result is different for a different order of rows, that is,

$$hash ( row 2 ‖ hash ( row 1 ) ) != hash ( row 1 ‖ hash ( row 2 ) ) .$$

Since the order of rows likely changes during the copy progress, this approach might fail.

Instead, the disclosed methods calculate a single order-invariant hash for all rows of the target database 250 that can then be compared to a single hash for all rows of the origin database 200. While the single hash enables a significantly more efficient comparison, it should also provide a good protection against hash collision, which means it should provide a robust detection of changes. In order to address these aspects, the disclosed method uses a hash array.

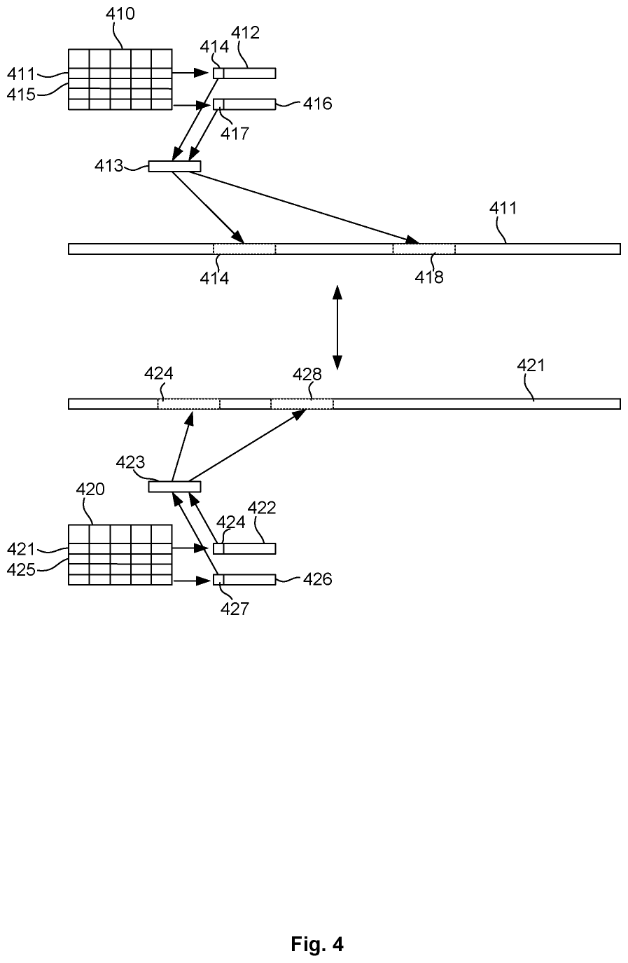

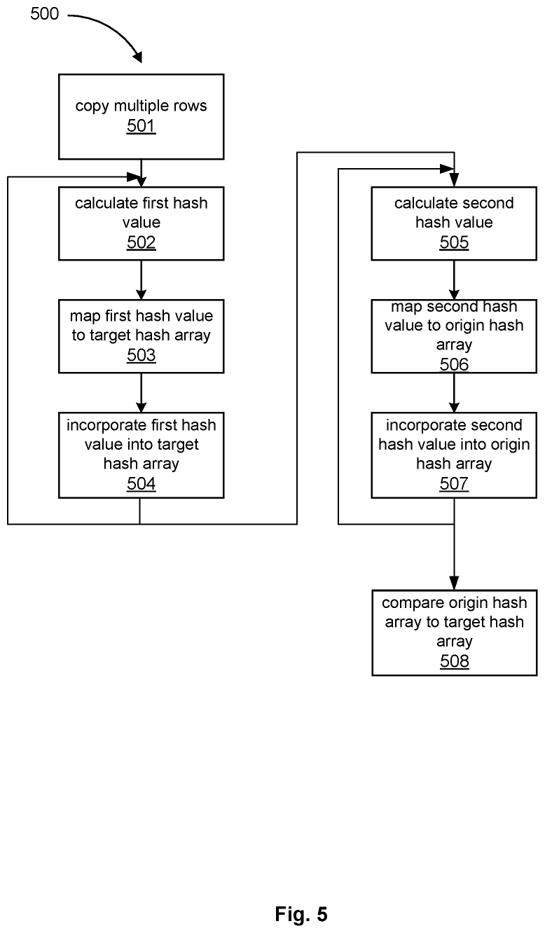

FIG. 4 shows data objects involved in migrating data from an origin database 410 to a target database 420. Correspondingly, FIG. 5 illustrates a method for verifying migrated data in target database 420 to the original data in origin database 410. It is noted that only one table is shown in origin database 410 and target database 420 but many more tables may be present and may be copied using the methods disclosed herein. The method is performed by a processor of an orchestrating server that issues database commands and queries and performs calculations as set out below.

First, the processor copies 501 multiple rows from the origin database 410 to the target database 420. The processor may employ the techniques disclosed herein for ordering the copied tables to ensure data consistency and for ordering the rows to be copied by physical storage location for acceleration. Once the rows are copied, the processor iterates over the multiple rows in the target database 420, which were copied in the previous step. In this iteration, the processor performs steps 502-504 in FIG. 5 to calculate a target hash array 421. The target hash array 421 is referred to as an array because it holds more than a single hash value as described below. In that sense, it is addressable with an index that starts at 0 and ends at the length of the array minus one. So a 256 bytes array would be addressed by an index of 0-255, for example. It is not necessary for the array to have separate segments or partitions and the array can be contiguous, similar to a char name[255] array in C language. Further, the array can have a different length, such as less than 256 bytes (e.g., 64 bytes) or more than 256 bytes (e.g., 512 bytes). In some embodiments, the array is an integer multiple of the length of the hash.

In order to calculate (or ‘fill’) the target hash array, the processor calculates 502 for that row 411 in the target database 410 a first hash value 412. In one embodiment, this is a SHA2-256 hash value with a length of 32 bytes. It is mentioned elsewhere herein that the hash calculation may exclude the cross-references (foreign keys) so as to avoid hashing any values that are generated automatically by the DBMSs, such as auto-increment primary keys. However, in some embodiments, the primary keys are not generated by the DBMS but instead a globally unique primary key is used. Therefore, the primary key and foreign keys are identical between the first database 410 and the second database 420 as explained herein. As a result, the hash function includes primary keys and foreign keys in those embodiments. However, the first database 410 and second database 420 may comprise an auto-incremented index that indicates the physical location where each row is stored on a storage medium. This physical index may be excluded from the hash calculation so as to avoid different hash values solely because the corresponding rows are stored in different physical locations.

The processor then applies a mapping function 413 to hash value 412 maps 503 the first hash value 412 to a position 414 in the target hash array 411. In some embodiments, the mapping function 413 uses one or more bytes, such as the first byte 414, of the hash value and maps the hash value 412 to a position in the target hash array 411 based on the one or more bytes, such as based on the first byte 414. In some embodiments, the mapping function 413 is a function of the one or more bytes. For example, the mapping function 413 may multiply the first byte 414 by a pre-defined number. The pre-defined number may be one less than the integer multiple that defines the length of the hash array 411 as a multiple of the length of the hash value. Therefore, multiplying the mapping factor with a maximum value of the one or more bytes results in the length of the target hash array.

In the example of a 32 byte long hash value and a 256 byte long hash array, that number would be 7. It is now clear that the target hash array 411 is longer than the first hash value 412 and the target hash array 411 may be configured to wrap around so that any index that is larger than the length of target hash array 411 starts again from the beginning from the array to point to a position within the array regardless of the value of the position. In that sense, the position may wrap around multiple times, such that, for example, a byte position of 512 still maps to a position within a 256 byte array.

Once the position is determined, the processor incorporates 504 the first hash value 412 into the target hash array 411 at the position. The incorporation can be any function of the first hash value 412 and the value of the target hash array 411 at the position. For example, processor may perform an XOR operation or may calculate a sum of the first hash value 412 and the value in the target hash array 411 at the position. While an XOR operation would be computationally less complex, the sum cannot detect odd number duplicates of rows because an XOR of the same row with itself and then the original value is just the original value. So if there are three copies instead of just one copy, this would lead to the same value using XOR but a different value using a summation.

The processor performs the above operations for multiple rows and FIG. 4 shows a second row 415 with a corresponding hash value 416 having a first byte 417 that is used by the same mapping function 413 to calculate a second position 418 that is now different to first position 414 assuming that first byte 417 is different from first byte 414. This way, the processor iterates over all copied rows in the target database 410 to ‘fill’ the single hash array 411. It is noted that this operation can be performed entirely locally on the first database 410 without a need to compare multiple hashes or find matching hashes, which would be required if hashes 412/416 were compared directly to hashes in the origin database 420.

Similarly, the processor iteratively performs the steps of 505-507 for each of the multiple rows in the origin database 420 that were copied to the target database 410 to calculate an origin hash array 421. That is, the processor calculates 505 for that row 421 in the origin database 420 a hash value 422 and uses a mapping function 423 of the first byte 424 to map 506 the hash value 422 to a position 424 in the origin hash array 421. The mapping function 423 is identical to the mapping function 413 and again, the origin hash array 421 is longer than hash value 422. The processor then incorporates 507 hash 422 value into the origin hash array 421 at the position 424. The processor performs these steps iteratively, such as for second row 425 to calculate second hash 426 with first byte 427 to be used by mapping function 423 to map the second hash value 426 to position 428. Again, the incorporation may be XOR, summation or another function. For completeness, it is noted that all comments made in relation to calculating the target hash array 411 equally apply to the calculation of the origin hash array 412.

Finally, the processor compares 508 the origin hash array 421 to the target hash array 411 to verify the multiple rows in the target database 410 against the multiple rows in the origin database 420. For example, the processor checks that the two hash arrays are identical, such as by an identity operation, such as “==”. If the hash arrays are identical, it can be concluded that the rows were copied correctly. Although there is a chance of a hash collision, this chance is significantly reduced by using a hash array that is longer than the hash values themselves. This is particularly significant if the number of copied rows is large, such as more than 10,000; more than 100,000; or more than 1,000,000 copied rows. For those large number of rows, it would be either very time consuming to match hashes directly for each row separately, or the risk of hash collision would increase to an unacceptable high number. For example, there is a 50% chance of collision for a 32 bit hash value when the number of hashes is only 77,163.

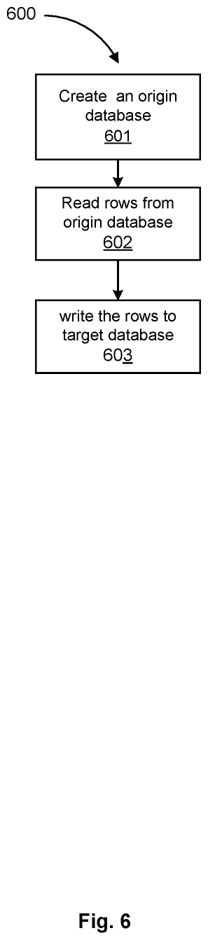

As alluded to above, the number of rows to be copied can be relatively large, such as over 1 million. Therefore, reading these rows out from the database takes considerable time and efficient reading would lead to a useful reduction in required read-out time. This is addressed in FIG. 6, which illustrates another process 600 for migrating data from an origin database 410 to a target database 420 as performed by a computer processor. The processor creates 601 the origin database by repeatedly adding rows to the origin database, such as by adding rows to a table of the origin database 410. This may apply to the invoices table 210 and the line items table 220 in FIG. 23. In this embodiment, each row comprises an attribute indicative of a physical location at which that row is stored on a non-volatile storage medium. This means that attribute is a number that is incremented each time a row is added to the origin database. This works because typically, a DMBS stores new rows adjacent to each other on physical memory as they are added to the database. This means that an increment of ‘1’ between the index of those rows means that those rows are located adjacent to each other. Reading out those rows in order significantly reduces the read-out time because most non-volatile storage devices, such as solid state disk or hard disk drive, are block devices that perform most efficiently when they read adjacent data records that can be read as part of the same block.

Therefore, the processor reads 602 the rows from the origin database in the order of the attribute indicative of the physical location. This is especially useful in cases where the primary key used to address each row is not an auto-increment value generated by the DBMS but a globally unique key because in that case, rows that are stored on adjacent physical storage locations may not have primary keys that only differ by ‘1’. In other words, each row added to the origin database comprises a primary key, different from the attribute indicative of the physical location. The primary key is unique to the origin database and the target database.

Finally, the processor writes 603 the rows from the origin database to a target database to migrate the origin database to the target database. The processor may then verify the records as described above with reference to FIGS. 4 and 5.

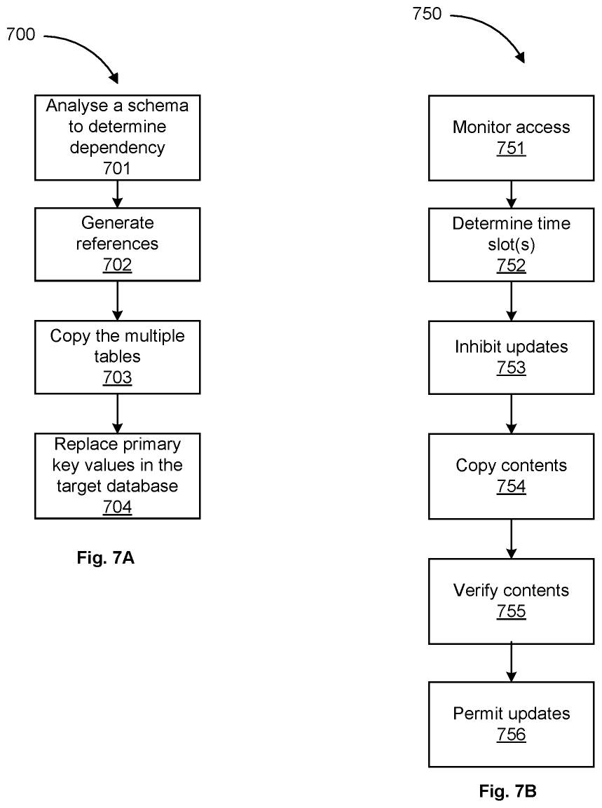

FIG. 7A is a diagram illustrating a process 700 for migrating data from an origin database to a target database. Process 700 summarises the steps described above. Processes 500, 600 or 700 are performed by a processor of a computer system that directs a DBMS, such as by sending queries or commands (SQL, ORACLE, etc.) to the DBMS for execution. For example, processes 500, 600 or 700 may be performed by processor(s) 508 of computer system 503 executing instructions stored in memory, such as data migration module 509, to perform processes 500, 600 or 700.

According to process 700, first the processor analyses 701 a schema of the origin database. The schema can be obtained through a database query or otherwise. Then, the processor determines from the schema, for multiple tables in the origin database, an order of dependency in which to migrate the multiple tables to the target database. This has been described above with reference to the graph in FIG. 3.

The processor then generates 702 references in the origin database to cross-reference rows in different tables independent from a primary key of the different tables. This has been described above with reference to the added temporary primary key column 214 and temporary invoice identifier column 225 (which may also be referred to as temporary foreign key column).

The processor then copies 703 the multiple tables in the order of dependency. The copied tables include the references in the target database that have been added in step 702. Finally, the processor uses 704 the references in the target database to replace primary key values that were in the target database and were assigned by the origin database. The processor replaces those primary key values with primary key values assigned by the target database as a result of adding new rows to the target database.

In some embodiments, the processor processes the tables one by one, which means the processor copies one table, replaces the primary keys in the copied table and then copies the next table after the primary keys have been replaced. It is further noted that copying a table does not necessarily mean creating a new table in the target database. Instead, there may already be a table on the target database that has the same name and the same columns. In that case, copying the table from the origin database comprises inserting the rows of that table on the origin database into the existing table of the target database. Once the copying is complete, the copied rows may remain on the origin database 200 or may be deleted from the origin database 200.

FIG. 7B is a diagram illustrating a process 750 for migrating data from an origin database to a target database. The method is also performed by a processor of a computer system that controls a DBMS through sending queries or commands to the DBMS to perform the steps set out in FIG. 7B. For example, process 750 may be performed by processor(s) 508 of computer system 503 executing instructions stored in memory, such as scheduling module 507 and data migration module 509, to perform process 750.

The processor monitors 751 access to the origin database over a period of time to capture usage data. As described above, the usage data may be for particular periods of time, such as hours and days. Then, the processor determines 752, based on the usage data, one or more suitable time slot(s) for performing data migration, such as where usage of the database is at a minimum. The processor may determine a data migration period based on the time slot(s). The processor inhibits 753 updates to the origin database during the data migration period to prevent changes to the origin database during migration. Also during that time of inhibited updates, the processor copies 754 contents of the origin database to the target database. Once the copping is complete, the processor verifies contents on the target database copied from the origin database against the origin database. Finally, upon successfully verifying the contents, the processor permits updates to the origin database.

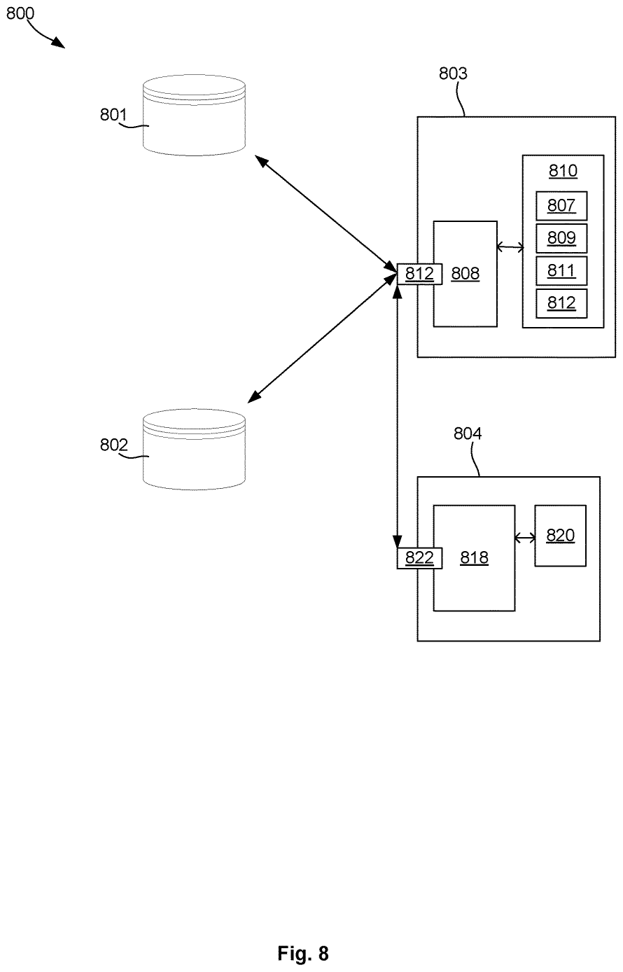

FIG. 8 is a schematic of a communication system 800 comprising an origin database 801 and a target database 802. A computer system 803 comprises one or more processors 808 and memory 810 storing instructions (e.g. program code) which when executed by the processor(s) 808 causes the computer system 803 to perform the methods disclosed herein, such as methods 500, 600, 700 and 750. In some embodiments, memory 810 comprises a data migration module 809 comprising instructions, which when executed by the processor(s), is configured to migrate data from an origin database to a target database, for example, in accordance with the method 700. In some embodiments, memory 810 comprises a scheduling module 809 comprising instructions, which when executed by the processor(s), are configured to determine a data migration period and migrate data from an origin database to a target database during the data migration period, for example, in accordance with the method 750. In some embodiments, memory 810 comprises a verification module 811 comprising instructions, which when executed by the processor(s), are configured to calculate a hash array for copied rows in the target database 801 and copied rows from the origin database 802 and compare the two hash arrays, for example, in accordance with the method 500. In some embodiments, memory 810 comprises a replication module 812 comprising instructions, which when executed by the processor(s), are configured to create an index indicative of a physical location of each row in the origin database 802 and copy the rows from the origin database 802 in the order of the physical location, for example, in accordance with the method 600.

Computer system 803 is controlling the origin database 801 and the target database 802 by way of sending queries or other commands to the databases 801/802 in order to perform the methods disclosed herein. Further, computer system 803 receives data from databases 802/803. In particular, computer system 803 sends a query for the database schema and receives data defining the schema of database 801 in order to analyse the schema and determine an order in which to copy tables to target database 802. Further, the computer system 803 issues a command, such as an SQL command of

$$UPDATE Line items SET InvoiceID\_t = 〈 pkey\_t 〉 where InvoiceID = 〈 pkey 〉$$

which updates the invoices table with re-generated temporary primary keys. Another possible SQL command is

$$UPDATE Invoices SET pkey\_t = 〈 pkey\_t 〉 WHERE pkey = 〈 pkey 〉 ,$$

which updates all line items that are cross-referenced with a particular invoice. The computer system 803 repeats this for each invoice (for example, each row in the invoices table).

Then, the computer system 803 copies the tables in the order of dependency as determined from the schema, copies the rows in the order of the physical storage index and verifies the copied data using hash arrays as described herein. For copying, the computer system 803 sends a query for one entire table at a time. That query may be configured to provide a specific coding or output format, such as an XML format. This is also referred to as serialization. In one example, the processor sends a SELECT*FROM Invoices statement that includes a CAST command to request an XML output. In one example, computer system 803 configures origin database 801 to return rows in the order as they are stored on the hard drive of the DBMS as per the index that is indicative of the physical location of each row (e.g., auto-increment attribute). This may be achieved using the SQL DBCC commands. This reduces movement of the read head and significantly reduces the query time.

Computer system 803 receives the serialized database content and may store it in a file on file storage or on a cloud storage. In another example, the origin database 801 streams the data directly to target database 802 so that the data does not need to be stored anywhere temporarily. Further, the data may be encoded in such a way that prevents other parties to access the data. The data may also be encrypted to protect it against eavesdropping attacks.

Computer system 803 sends commands to the target database 802 to create new rows and fill those rows with the stored serialized data from the origin database 801. This can be achieved by the SQL command INSERT INTO. This also involves deserialization and decoding the stored data. The steps of retrieving the table content from origin database 801 and inserting them into the target database 802 is referred to as “copying” the tables.

It is noted again that the order of rows reflects the storage locations on the hard drive of the origin database 801, which means the rows are most likely not ordered by their primary key. Therefore, the order of the rows stored on the target database 802 is most likely different to the order on the origin database 801. This again highlights the problems with foreign keys that are not preserved as cross-references by default. Therefore, the computer system 803 uses the previously generated references to replace the primary key values in the foreign key column in the target database. This restores the cross-references from the origin database 801.

It is also noted that computer system 803 does not need to be a single computer system but may be a distributed system of multiple computers or processors. Further, databases 801 and 802 are separate in the way that a table with the same name and structure can exist on both databases independently from each other in the sense that the primary keys are generated independently. As a result, the primary keys are not unique across both databases, which means that a primary key value in a table in origin database 801 may also exist in the same table in the target database 802. Therefore, databases 801/802 may be hosted by two remote computer systems, as virtual machines on the same physical computer system or a range of other implementations.

The computer system 803 comprises one or more processors 808 and memory 810 storing instructions (e.g. program code) which when executed by the processor(s) 808 causes the computer system 803 to manage accounting aspects for a business or entity, provide accounting functionality to the one or more computing devices and/or to function according to the described methods. The processor(s) 808 may comprise one or more microprocessors, central processing units (CPUs), application specific instruction set processors (ASIPs), application specific integrated circuits (ASICs) or other processors capable of reading and executing instruction code.

Memory 810 may comprise one or more volatile or non-volatile memory types. For example, memory 810 may comprise one or more of random access memory (RAM), read-only memory (ROM), electrically erasable programmable read-only memory (EEPROM) or flash memory. Memory 810 is configured to store program code accessible by the processor(s) 808. The program code comprises executable program code modules. In other words, memory 810 is configured to store executable code modules configured to be executable by the processor(s) 808. The executable code modules, when executed by the processor(s) 808 cause the computer system 803 to perform certain functionality, as described in more detail herein.

The computer system 803 further comprises a network interface 812 to facilitate communications with components of the communications system 800 across a communications network, such as database 801/802 and/or other servers, including financial institute or banking server. The network interface 812 may comprise a combination of network interface hardware and network interface software suitable for establishing, maintaining and facilitating communication over a relevant communication channel.

A computing device(s) 804 comprise one or more processors 818 and memory 820 storing instructions (e.g. program code) which when executed by the processor(s) 818 causes the computing device(s) 804 to cooperate with the computer system 803 to provide accounting functionality to users of the computing device(s) 804 and/or to function according to the described methods. To that end, and similarly to the computer system 803, the computing devices 804 comprise a network interface 822 to facilitate communication with the components of the communications network. For example, memory 820 may comprise a web browser application (not shown) to allow a user to engage with the computer system 803. In some embodiments, memory 820 may comprise a database migration application (not shown) associated with the computer system 803, which when executed by processor(s) 818, enables the computing device 804 to allow a user to migrate a business's records (such as financial records or accounting/bookkeeping records) from the origin database 801 to the target database 802 via interaction with a user interface provided by the computer device 804.

Origin and target databases 801/802 may be configured to store business records, banking records, accounting documents and/or accounting records associated with entities having user accounts with the computer system 803, availing of the services and functionality of the computer system 803, or otherwise associated with the computer system 803. The computer system 803may also be arranged to communicate with financial institute server(s) or other third party financial systems (not shown).

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A method comprising:
copying multiple rows from an origin database to a target database;
iteratively performing the following steps for each of the multiple rows in the target database that were copied from the origin database to calculate a target hash array:
calculating for that row in the target database a first hash value;
mapping the first hash value to a position in the target hash array, the target hash array being longer than the first hash value; and
incorporating the first hash value into the target hash array at the position;
iteratively performing the following steps for each of the multiple rows in the origin database that were copied to the target database to calculate an origin hash array:
calculating for that row in the origin database a second hash value;
mapping the second hash value to a position in the origin hash array, the origin hash array being longer than the second hash value; and
incorporating the second hash value into the origin hash array at the position; and
comparing the origin hash array to the target hash array to verify the multiple rows in the target database against the multiple rows in the origin database.

2. The method of claim 1, wherein mapping the first hash value to the position in the target hash array is based on the first hash value.

3. The method of claim 2, wherein mapping the first hash value to the position in the target hash array is based on one or more bytes of the first hash value.

4. The method of claim 3, wherein the one or more bytes are leading bytes.

5. The method of claim 3, wherein mapping the first hash value to the position in the target hash array comprises multiplying the one or more bytes of the first hash value by a mapping factor and using a result of the multiplying as an index in the target hash array.

6. The method of claim 5, wherein multiplying the mapping factor with a maximum value of the one or more bytes results in a length of the target hash array.

7. The method of claim 1, wherein the target hash array wraps around in case the first hash value overflows the target hash array.

8. The method of claim 1, wherein incorporating the first hash value into the target hash array comprises adding the first hash value to values in the target hash array at the position.

9. The method of claim 1, wherein the first hash value has 32 bytes and the target hash array has 256 bytes.

10. The method of claim 1, wherein steps of calculating, mapping and incorporating are identical for creating the target hash array and for creating the origin hash array.

11. A method comprising:
creating an origin database by repeatedly adding rows to the origin database, each row comprising an attribute indicative of a physical location at which that row is stored on a non-volatile storage medium;
reading the rows from the origin database in an order of the attribute indicative of the physical location; and
writing the rows from the origin database to a target database to migrate the origin database to the target database.

12. The method of claim 11, wherein the attribute is a number that is incremented each time a row is added to the origin database.

13. The method of claim 11, wherein each row added to the origin database comprises a primary key, different from the attribute indicative of the physical location, the primary key being unique to the origin database and the target database.

14. A method comprising:
analysing a schema of an origin database to determine, for multiple tables in the origin database, an order of dependency in which to migrate the multiple tables to a target database;
generating references in the origin database to cross-reference rows in different tables independent from a primary key of the different tables;
copying the multiple tables in the order of dependency and including the references in the target database; and
using the references in the target database to replace primary key values in the target database and assigned by the origin database with primary key values assigned by the target database.

15. The method of claim 14, wherein copying the multiple tables comprises copying rows of each of the multiple tables according to an order as the rows are stored on a non-volatile storage medium.

16. The method of claim 14, wherein analysing the schema comprises identifying dependencies and wherein the order comprises positioning a first table of the multiple tables before a second table of the multiple tables if the second table depends on the first table.

17. The method of claim 14, wherein a dependency of a first table of the multiple tables on a second table of the multiple tables comprises a use of a foreign key in the first table, the foreign key reflecting a primary key in the second table.

18. The method of claim 14, wherein a first table of the multiple tables depends on a second table of the multiple tables and the method comprises copying the second table before the first table.

19. The method of claim 14, wherein replacing the primary key values in the target database is performed for a table of the multiple tables copied from the origin database and before copying a further table of the multiple tables from the origin database.

20. The method of claim 14, wherein generating references comprises adding a reference column to each of the multiple tables and storing the references in the reference column.

21. The method of claim 14, wherein each of the multiple tables in the origin database has a corresponding table in the target database and a reference is unique across one of the multiple tables in the origin database and the corresponding table in the target database.

22. The method of claim 14, wherein generating the references comprises generating one reference for each primary key value in the origin database.

23. The method of claim 14, wherein a first table of the multiple tables depends on a second table of the multiple tables and generating the references comprises generating a reference for each row in the second table and using that reference for each corresponding foreign key in the first table.

24. A method comprising:
monitoring access to an origin database over a period of time to capture usage data;
determining, based on the usage data, one or more time slots where usage of the origin database is at a minimum;
determining a data migration period based on the one or more time slots;
inhibiting updates to the origin database during the data migration period to prevent changes to the origin database during migration;
copying contents of the origin database to a target database;
verifying contents on the target database copied from the origin database against the origin database; and
upon successfully verifying the contents, permitting updates to the origin database.

25. The method of claim 24, wherein monitoring the access comprises capturing time stamps of operations performed on the origin database.

26. The method of claim 25, wherein the method further comprises aggregating the usage data for multiple pre-defined time slots.

27. A system comprising:
one or more processors; and
memory comprising computer executable instructions, which when executed by the one or more processors, cause the system to perform the method of claim 1.

28. A non-transitory machine-readable storage medium including instructions that, when executed by a machine, cause the machine to perform the method of claim 1.
